(19) United States
(12) Patent Application Publication
(10) Pub. No.: US 2008/0215705 A1
(43) Pub. Date: Sep. 4, 2008

(54) REMOTELY CONTROLLED REAL-TIME AND VIRTUAL LAB EXPERIMENTATION SYSTEMS AND METHODS

(76) Inventors: Wayne Po-Wen Liu, Los Angeles, CA (US); Peter Patrick DeGuzman, Orange, CA (US); Uichong Brandon Yi, Los Angeles, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/027,989

(22) Filed: Feb. 7, 2008

Related U.S. Application Data
(60) Provisional application No. 60/888,740, filed on Feb. 7, 2007.

(51) Int. Cl. G06F 15/16

(52) U.S. Cl. 709/217

(57) ABSTRACT

Remotely controlled platforms for experimentation provide for centralized placement of costly and space consuming experimentation equipment. Additionally, remotely controlled platforms take advantage of economies of scale to make the centralized experimentation platforms more available for students and researchers of institutions that cannot afford to have institutional ownership of the experimentation platforms.

### RELATED APPLICATIONS

This application claims the benefit of and Paris Convention priority to U.S. Provisional Application Ser. No. 60/888,740, filed Feb. 7, 2007, the contents of which are incorporated by reference herein in its entirety.

### BACKGROUND

This invention relates to the methods of scientific experimentation, in particular, the conduct, archiving and synthesis of experimental work achieved through remote testing.

As the sophistication and cost of scientific discovery increase, many educational institutions and even small R&D companies find it hard to procure state of the art experimentation platforms, not only by the cost of the dedicated facilities, hardware (microscopes, electronic instruments), and samples (DNA, cell solutions, chemicals), but also by the infrastructure needed to maintain such labs (instructors, technicians, lab safety compliance, Hazmat storage/disposal). By developing highly scalable remote experimentation platforms, opportunities in scientific experimentation and education can be diffused globally to researchers and students who lack access to critical lab facilities, hardware, and instruction.

Massively scalable remote testing capabilities can be achieved by building remote test centers about a Digital Microfluidic (DMF) platform; DMF platforms have presented biochip designers and scientists with the capability to script fluidic processes droplet by droplet (10 nL-100 μL) and with precise timing and point-to-point droplet travel control. DMF platforms can be driven by Electrowetting-on-Dielectric (EWOD) sample handling technology to route, generate, mix, and split discrete liquid droplets on or between electrode-patterned glass plates (100-300 micron gap) by modulating the local surface wettability via voltage pulses.

The on-chip capability to electronically reconfigure sample processing paths and generate sample droplets from an on-chip sample reservoir represents the enabling drivers for highly scalable remote testing. Furthermore, the scripting of droplet travel (and hence experimentation protocols) is done by constructing a simple schedule of time based electrode voltages and pulse durations; this programming of the digital experimentation process can thus be transferred to other users to repeat or modify experimentation processes without having to recreate the programs. While DMF has been aimed mostly at advanced R&D applications, here we identify its unique capability to support: 1) remote testing and 2) archiving and synthesis of on-line DMF testing protocols for a community of experimentalists.

### SUMMARY

Remotely controlled platforms for experimentation provide for centralized placement of costly and space consuming experimentation equipment. Additionally, remotely controlled platforms take advantage of economies of scale to make the centralized experimentation platforms more available for education institutions and researchers of institutions that otherwise could not afford to have institutional ownership of the experimentation platforms.

According to a feature of the present disclosure, a system is disclosed comprising an experimentation platform controlled by a first computer, a second computer in communication with the first computer and located at a remote location, wherein an experiment using the experimentation platform may be conducted by inputting at least one instruction on the second computer, and wherein the second computer relays the at least one instruction to the first computer for controlling the experimentation platform.

According to a feature of the present disclosure, a method is disclosed comprising providing an experimentation platform controlled by a first computer and providing an interface to allow a second computer to issue remote commands to the first computer to control the experimentation platform remotely. Alternatively, the second computer could issue commands directly to experimentation platforms for those apparatuses that are equipped to be connected over the chosen communications protocol.

According to a feature of the present disclosure, a method is disclosed comprising centralizing a plurality of experimentation sites into at least one subset of experimentation sites, connection experimentation hardware to a first set of computers, and providing an interface to control experimentation apparatuses from remote location using a second computer.

According to a feature of the present disclosure, there is disclosed a machine-readable medium having program instructions stored thereon executable by a processing unit for performing the steps comprising providing for communication between a first computer and a second computer and providing an interface for controlling an experimentation platform via the first computer from the second computer, wherein the experimentation platform and first computer are located remotely.

### DRAWINGS

The above-mentioned features and objects of the present disclosure will become more apparent with reference to the following description taken in conjunction with the accompanying drawings wherein like reference numerals denote like elements and in which:

FIG. 1 is block diagram of an embodiment of a system allowing for remote control of an experimentation apparatuses;

FIG. 2 is a top, time-lapsed view of an embodiment of an experiment performed on a digital microfluidic device wherein a drop of fluid is moved on a digital microfluidic platform according to instructions provided from a remote location;

FIGS. 3A-3D are top views of embodiments of an experiment performed on a digital microfluidic device taken over time demonstrating how a droplet may be divided from a stock source of a fluid according to instructions provided from a remote location;

FIGS. 4A-4D are top views of embodiments of an experiment performed on a digital microfluidic device taken over time demonstrating how two droplets may be mixed together according to instructions provided from a remote location; and

FIG. 5 is a diagram of an embodiment of an experiment demonstrating the possible outcomes of an experiment, which illustrates the number of prerecorded video clips that would be necessary to show each permutation of an experiment.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, biological, electrical, functional, and other changes may be made without departing from the scope of the present invention. The following detailed description is, therefore, not to be taken in a limiting sense, and the scope of the present invention is defined only by the appended claims. As used in the present disclosure, the term “or” shall be understood to be defined as a logical disjunction and shall not indicate an exclusive disjunction unless expressly indicated as such or notated as “xor.”

Appendices A, B, and C are hereby incorporated by reference as if fully disclosed herein. U.S. Provisional Application Ser. No. 60/683,476, filed on 21 May 2005, is hereby incorporated by reference as if fully disclosed herein. PCT Application Serial No. PCT/US2006/019425, filed on 18 May 2006, is hereby incorporated by reference as if fully disclosed herein.

As used herein, the term “remote” shall be defined as: placed or situated at a distance or interval from each other; far apart. In the context of devices, these devices are far enough apart that a network adapter or other similar apparatus is used to interconnect the devices.

The invention greatly improves the content and scale of remote testing by conducting experiments on a reconfigurable digital microfluidic (DMF) platform that can be programmed to achieve different fluidic handling protocols and which can create different sample sets and concentrations through on-chip droplet generation. Artisans will readily recognize that the principles disclosed herein are applicable to many experimentation platforms in addition to DMF or lab on a chip type applications.

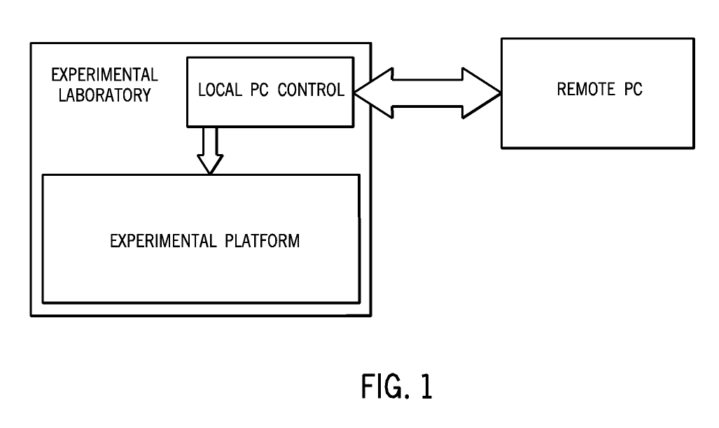

As shown by an embodiment of FIG. 1, a system for conducting experiments that may be controlled remotely is shown. The system is operated by a user using a remote second device (remote device or computer), such as a computer, cell phone, etc. operated at a remote location from the experimentation platform. The remote device sends experimentation protocol instructions to a first device (local device or computer), such as the experimentation platform itself or to a computer directly connected to the experimentation platform. According to embodiments, the experimentation platform include DMF platforms, sample libraries, and sample analyzers, including microscopes, imaging software, electricity sources and meters, optical or electronic analyzers, and sensing or immunocapture electrodes, DNA sequencers, PCR machines, etc. Likewise according to embodiments, the samples may be biofluids, reagents, labels, etc.

According to embodiments, the remotely controlled system for conducting experiments allows users to perform experiments using real-time and virtual methods and via assembly of protocol subroutines. Users control experimentation platforms at a remote location using a remote computer connected to a local computer connected to the experimentation platforms. Artisans will recognize that the present system is compatible with any experimentation platform that may be controlled by a device such as a computer and monitored through video or sensory feedback.

According to exemplary embodiments, microfluidic devices provide an ideal platform for remote experimentation. Accordingly, internet control/monitoring of a programmable DMF platform provides a range of remotely operated experimentation experiences. The range of experimentation experiences varies, according to embodiments, depending on the audience. High school students will have different objectives from college students, who may have different objectives from researchers, for example. In one such embodiment, fully automated, but user-paced, scientific demonstrations for primary and high school students is provided, allowing for microscopic imaging of electrolysis, chemiluminescence, and surface wetting. In another embodiment, a partially automated experimentation platform for requires some user scripting of DMF processes, which provides for titration, enzymatic reactions, and other simple assays. According to still another embodiment, open programming (minimally automated) allows for the development of highly specific, user-designed assays aided by stock or preprogrammed DMF processes. Accordingly, the applications of the present disclosure range from fully automated experimentation examples on a microfluidic device to fully programmable experiments that allow the remote user to perform experiments as if the experimentation platform were local.

An interface is provided that allows the remote second device to interface with and control the first device. Such an interface may comprise, according to embodiments, a set of instructions that is sent from the second device to the first device. Upon receiving the instructions, the first device causes the experimentation platform to execute the intended instructions. Artisans will readily understand that the interface may comprise a networking interface, such as TCP/IP or a similar or proprietary interface that provides a set of commands that may be input on the remote computer and transmitted to the local computer, which causes the performance of an action by the experimental apparatus. According to embodiments, such an interface may comprise a webpage or other graphical user interface (GUI) that is hosted on the local computer and transmitted as a webpage or other graphical object to the remote computer. The webpage/GUI allows input of commands according to well-known and understood methods for input data through a webpage. The data is transmitted via the browser on the remote computer to the local computer according to standard internet protocols. The local computer then interprets the commands and causes the experimentation apparatus to perform the action that is desired by the remote user.

Experiments that are able to be performed on such microfluidic devices include simple mix and observe type chemical or physical reaction experiments that have quick or instantaneous results. However, the present inventors also expressly contemplate as part of the present disclosure more complex experiments that require longer periods of time, in some cases days, to perform. For example, E. coli cultures may be grown on the DMF platform. Accordingly, environmental conditions may be varied, such as temperature, growth media concentrations, antibiotics, etc. to allow remote users to observe the growth of bacteria as the environmental conditions are varied. Similarly, DNA plasmids may be reacted with restriction enzymes, ligated with DNA constructs, transformed into a bacterial host, amplified, and sequenced. Artisans will readily understand the many permutations of experiments that may be performed according to the present disclosure.

According to embodiments, the DMF platform is especially cost effective for high school and college classrooms. By creating a global user community, students and instructors can review, download, and upload their own DMF protocols to build and learn from a library of user-designed scientific demonstrations, much like technical papers currently allow review and sharing of lab results. To achieve mass adoption as a tolerant student learning platform, the DMF chip should possess the following technical attributes, according to embodiments:

1) Provide robust scaling in chip control and droplet path reconfiguration;
2) Endure intermittent pauses, repeats, and reconfigurations in the sample handling processes for a variety of biological and chemical fluids;
3) Enable chip control and video monitoring of the microfluidic processes through internet; and
4) Support an array of biological, chemical, and physical experiments that are meaningful to the curriculum.

According to embodiments, electrowetting on dielectic (EWOD) droplet driving based DMF chips provide a suitable platform for the principles of the present disclosure.

A brief overview of the EWOD droplet actuation, generation, mixing, and splitting illustrates the utility of the present disclosure for manipulation of experimentation platforms remotely. When an electric potential is applied between a droplet and an underlying electrode on the DMF chip, the induced polarization of the dielectric layer alters the free energy at the surface, resulting in an increase in the surface wettability and a decrease in the contact angle of the droplet with the surface. The Lippmann-Young equation

$$cos θ = cos {θ}_{0} + \frac{1}{{γ}_{LG}} \frac{1}{2} {cV}^{2}$$

describes the relationship between the initial contact angle (θₒ), applied voltage (V), resultant contact angle (θ), liquid-gas surface tension (γ_{LG}), and the specific capacitance (c) of the dielectric layer.

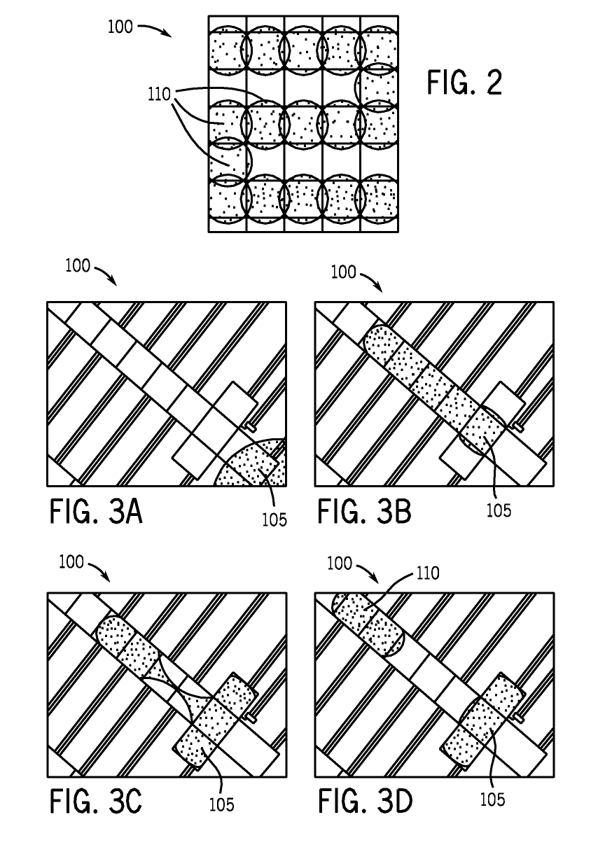

When electric potential is applied across a capillary droplet from top/bottom parallel plates, large contact angle changes, Δθ (˜40 deg) between the droplet's left (non-wetting) and right (wetting) edge, can be achieved to produce droplet displacement to the right. FIG. 2 illustrates this principle in a time lapsed view, showing the movement of a droplet 110 of a “2” on microfluidic device 100. In this manner, EWOD effects enable programmable droplet (submicroliter) transport within a planar air gap, using only patterned electrodes and no pumps, channels, or valves.

Similarly, droplets may be generated by separating a small droplet from a source droplet, as illustrated in FIGS. 3A-3D. Without the aid of hydrodynamic instabilities, large displacements must be applied to “cut” a droplet free from a liquid volume that is bounded by a parallel-plate channel. To achieve these displacements, controlled EWOD wetting is applied to stretch fluid source 105 sideways from the fluid column to generate droplets. As shown in FIGS. 3A to 3D, fluid source 105 is necked down on microfluidic device 100 immediately downstream of the side electrodes to provide a consistent cutting point for repeatable droplets 110. Recent testing has shown that the volume of droplet 110 can be controlled to within 1% by combining real-time capacitive feedback to modulate the electronic droplet extraction pulses.

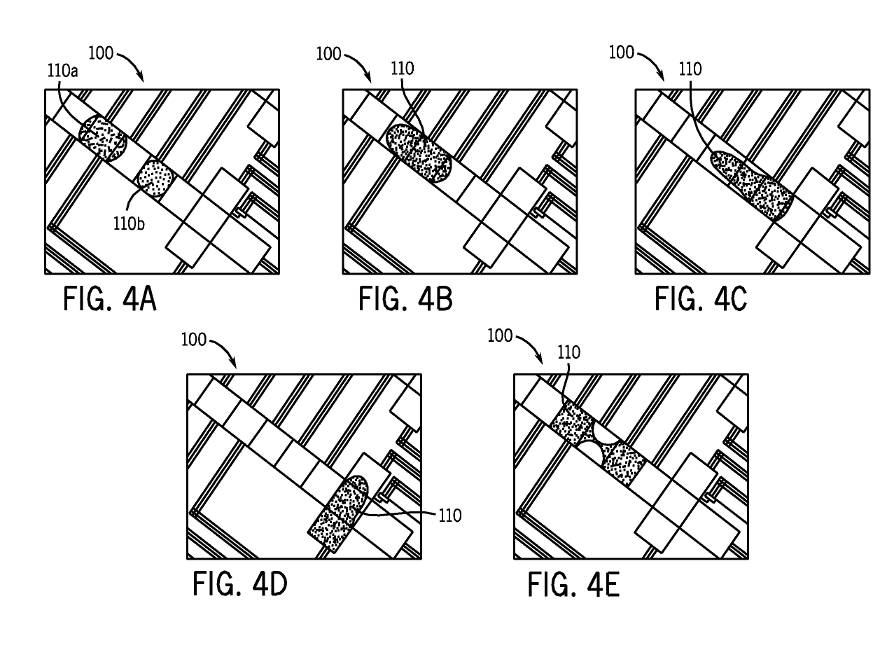

As a logical extension of the EWOD principle, droplets 110a and 110b may be mixed and split as illustrated in FIGS. 4A to 4D. Mixing is achieved by collecting or merging discrete droplets 110a and 110b at a single pad and then agitating the newly formed droplet 110. Agitation is achieved by moving droplet 110 in multiple directions, as illustrated in FIGS. 4B through 4D. Splitting is achieved by simultaneously activating opposite electrode paths that are adjacent to sitting droplet 110; droplet 110 is thus pulled in opposite directions to neck down and eventually disconnect any connecting fluid. Table 1 is exemplary of the many reagents that are able to be used in conjunction with the exemplary DMF platform for remote experiments.

TABLE 1
Biofluids that are EWOD drivable on dry surface
in air

| | Max. | |
|---|---|---|
| Test solution | concentration | |
| Phosphate Buffered Saline (PBS) | 100% | PBS |
| Dimethyl Sulfoxide (DMSO) | 100% | DMSO |
| Doxorubicin hydrochloride in DMSO | ~156 | mg/mL |
| Doxorubicin hydrochloride in | ~25 | mg/mL |
| DMSO:H₂O (1:1) mix | | |
| B16F10 Melanoma cells in PBS | ~3 × 10⁵ | cells/mL |
| E. coli, Listeria cells in PBS | ~6 × 10⁶ | cells/mL |
| HRP in PBS | 5 | units/mL |
| K₄Fe(CN)₆•3H₂O | 0.5 | μM |
| Insulin | 1 | μM |
| H₂O₂ | 30% | |
| PEG solution | 1% | w/v |
| Calf thymus | 4 | μg/ml |
| BSA in PBS and sucrose | 1000 | μg/ml |
| Alfafetoprotein in PBS and sucrose | 1 | μg/ml |

To support a wide range of experiments, EWOD droplet driving for a large variety of buffers, microbeads, bacteria, DNA, and chemical solutions have been performed. Many of the biofluid solutions have the potential to foul and prevent EWOD actuation at low concentrations as disclosed and addressed in U.S. Provisional Application Ser. No. 60/683,476, filed on 21 May 2005 and PCT Application Serial No. PCT/US2006/019425, filed on 18 May 2006, which are incorporated by reference. These anti-fouling techniques differ from the well-known approach of coating the chip surface with PEG to prevent adsorption; if the EWOD chip is coated with PEG, the surface becomes permanently hydrophilic and the ability to switch between hydrophobic/hydrophilic states (necessary for droplet actuation) is lost.

Because DMF devices are relatively small, they are highly scalable. Thus, multiple experiments may be performed on a single DMF device at any given time, according to embodiments. Accordingly, an array of video capture devices would be located over the DMF device, thereby scaling up capacity. Likewise, other experimentation platforms may be similarly scalable.

Additionally, for point-to-point fluidic sample handling on DMF chips, a number of assays can be performed on discrete and predetermined test zones, for example a 10 pad by 10 pad zone designed for test X and a separate 20 by 20 pad zone designed for test Y. However, to be more space efficient, DMF chips can perform a number of independent assays serially on a generic 2D matrix of electrodes, such that each assay starts at a point on the matrix where the previous assay finished. Thus, like writing data to a hard drive or CD (where file space is not predetermined but allocated according to file size) test space on the DMF array is consumed by each assay on an as needed basis and not in predetermined fashion. Software programs can track and utilize spare or unused pads on the wafer to conduct repeat or new assays and thus minimize the percentage of wasted or unused pads on any wafer.

Many DMF devices employ a circuit-like pattern of EWOD electrodes to circumvent the difficulty of connecting to interior pads or pads that are blocked from horizontally running signal connection wires. As a result, there is often much dead space on a DMF chip to enable wire connections; this limits higher chip densities as well as reconfiguration potential. To achieve greater scaling and reconfiguration potential, the inventors recently demonstrated a unique chip design, which can yield a two dimensional (2-D) or M×N matrix of electrodes with little or no dead space and requires only M+N control channels. FIG. 2-4 shows how the M+N cross-referencing chip can address any position within an M×N array of electrodes using a row of M electrode bars (driving signal) on the substrate and an orthogonally aligned row of N electrode bars (common ground) on the cover slide. Thus, scaling advantages are achieved as the number of addressable locations scales with the product of array dimensions (M×N) while chip control scales with the sum of array dimensions (M+N).

Recently, the PI has demonstrated an advanced variant of the M+N chip concept which co-locates all driving and common ground connections on the substrate [15] (coplanar contact with droplet instead of top/bottom contact as in FIG. 2-2). Thus droplet driving is enabled without a cover slide or with a cover slide that is free from droplet actuation and instead can be user-functionalized (sensors, immuno-capture sites, microarrays). FIG. 2-5 shows a droplet traveling on a single tracked or 1-D M+N coplanar chip without a cover slide; Phase I research will deliver a 2-D M+N coplanar chip prototype.

### Real Time Experiments

According to embodiments, users input a protocol or steps remotely, which are performed by the experimentation platforms locally. According to embodiments, protocols may either be entered in blocks of steps prior to the steps being performed, including all of the protocol steps or a portion of the protocol steps. Similarly, according to other embodiments, users enter each step in real-time, which is, once one-step is complete the user will enter the parameters for the subsequent step, which allows the users to observe the progress of the experiment and make modifications to the protocol as necessary.

Protocol instructions or steps entered by remote users are any instructions that could otherwise be performed by direct use of the device controlling the experimentation platform, according to embodiments. Depending on the implementation, commands need not map one-to-one from remote device to the local device connected to the experimentation platform; rather, specific implementations may be devised to optimize or streamline remote use by using asymmetric mappings of commands. For example, each remote command may be devised to perform one or more commands that would be necessary if entered on the device that is directly controlling the experimentation platforms.

According to embodiments, real-time use of the experimentation platforms is effective using “lab on a chip”-type technologies, such as DMF platform. These types of technologies allow for experimentation protocols to be performed in a single location, without the need to move solutions between glassware, etc. Moreover, transmission of video images of the chip are feasible allowing users to observe the experiment in real-time.

Similarly, according to embodiments, the experimentation set up may be automated or be set up on a case-by-case basis. According to this embodiment, human intervention at the remote site may be used to prepare the labs on a chip. For example, labs on a chip may be produced having the reagents necessary to perform an acid base titration experiment for high school classes. It may therefore be necessary to exchange chips from time to time after one or more experiments have been performed. According to related embodiments, users may contact the remote lab and have a chip having the necessary reagents prepared in advance of the experiment. According to other embodiments, the chips are reparable and replaceable by an automated system.

According to embodiments, by having the experiments performed and run on a DMF platform, for example, users have a virtually unlimited ability to manipulate the reagents, etc. Indeed, as shown in FIGS. 2-4, a droplet containing a reagent can be moved, split from a stock of reagent, and mixed with another reagent. Other possible manipulations on a DMF platform are known to artisans and applicable here, such a heating and cooling, etc.

### Virtual Experiments

According to an embodiment, the remotely controlled system may also return the video of a virtual experiment, rather than real-time video. Similar to performing a real-time experiment, video segments or slices from a prerecorded experiments are recalled and replayed as various protocols are executed over the course of a virtual experiment. Instead of controlling a live experiment, which is recorded and monitored in real time by the user, each instruction relayed from the remote compute to the local computer during a virtual experiment would recall and replay a video segment from a prior experiment that was achieved with the same inputs and protocol steps. According to embodiments, each experiment performed in real time may be recorded and added to a database of experiments, thereby individualizing each experiment shown as a prerecorded video clip. Video clips may be streamed from a remote site or downloaded to each remote location for viewing to prevent periodic stopping due to insufficient buffering, as well as jittery playback.

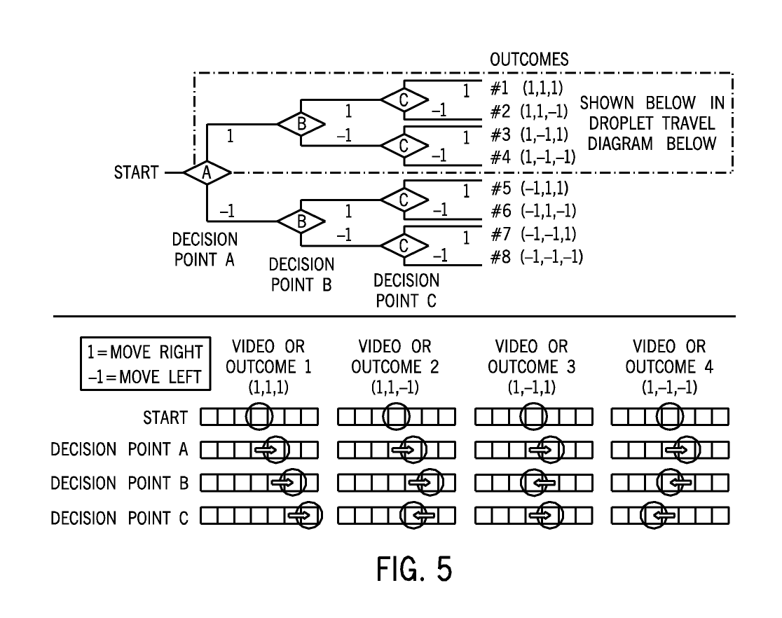

For example and as shown in FIG. 5, a three-step experiment is shown. For each step or decision point, two options exist—moving left or right along a DMF platform. As shown in FIG. 5, a total of 2ⁿ or 8 experimentation sequences or outcomes are possible (2 options each time at n decision points) necessitating a total of 14 video segments or clips (i.e., 2¹ at decision point A+2² at decision point B+2³ at decision point C). For a three step experiment, a total of 8 possible experimentation sequences (outcomes) exist for arriving at 4 discrete outcomes (i.e., the position of the droplet on the DMF platform at the end of the experiment). As artisans will recognize, by prerecording each possible option at each decision point in the experiment, the appropriate prerecorded sequence for any of the 8 experimentation outcomes may be recalled and shown later during a virtual experiment. By recording each experiment performed in real time for users utilizing the experimentation platform in real time and storing the resultant video in a database of video clips, over time many different permutations of each experimentation procedure will be available for viewing.

To accommodate variations in the experimentation process, protocol variations may be recorded, which will allow users to make mistakes or arrive at the same result by variations in their experimentation paths. Similarly, enabling interactive input of steps by the user allows for mistakes to be made over the course of an experiment and allows the user to observe the effects of the mistakes, correct, and compare to the desired experimentation outcome or the outcomes of others. Moreover, allowing mistakes and variations in the experimentation process enables the users to learn data interpretation and analyze the experimentation outcomes based on both good and bad experimentation protocols and execution.

Artisans will recognize that the number of steps in a given experiment could make prerecording each possible step in an experimentation protocol inefficient in terms of cost to benefit. For example, one cannot titrate an acid with a buffer without first having an acid solution and a pH indicator added to the solution. Therefore, prerecording of a buffer being first added to an empty position on a DMF platform may be unnecessary because experimentation protocols will never place this step before the others. However, users may add to a DMF platform position either a starting acid solution or the pH indicator with no effect on the outcome of the experiment. Thus, for protocol steps that are either impossible or unlikely to produce a useful teaching opportunity at a given point in the experiment may be omitted from the library of prerecorded clips, according to embodiments. This will, in cases where possible number of steps exceeds a reasonable number, reduce the number of prerecorded clips necessary.

Thus, according to embodiments, users have the option of conducting an entire virtual experiment remotely. At each step, a prerecorded clip will be displayed—if the user performs the protocol incorrectly, omits a step, or adds a step, the unintended results will be shown to the user, as the exact sequence of incorrect procedure will be prerecorded with the correct sequence.

Artisans will readily appreciate that the principles of the present disclosure are applicable for single remote users. According to embodiments, however, the apparatuses and methods of the present disclosure are also able to be utilized by a plurality of remote users that observe and control the experiments remotely. For example, a high school lab group could work in unison from disparate remote locations to perform an experiment. It will be recognized that only a single user will issue commands to the experimentation platform at any given time, according to embodiments, and each user may observe the experimentation platform simultaneously.

Similarly, using a database, each experiment performed by a remote user may be recorded for review or comparison to other experiments, according to embodiments. Thus, a professor can aggregate data to show the class trends and teach data interpretation, for example. Alternatively, the professor may review the experiments on an individual basis to evaluate each user's experiment. Artisans will recognize that the ability for the system to record each experiment, whether performed in real time or using prerecorded video clips, gives users a platform whereby use of the recorded experiments allows for a variety of functions, including those listed above, as well as critiquing the experiment, addressing data abnormalities, etc.

In certain settings, audio effects may be added to the video viewed at the remote location for a more engaging end product. For example, high school students may need additional stimulus to pay attention to the experiment. Audio effects may be dubbed over previously recorded experiments, or may be cued depending on the instructions and results of the experimentation platform. For example, the remote system may automatically play a “splashing” sound each time droplets are mixed together or a “doink” sound every time the droplet is moved. These audio effects, according to embodiments, may be cued as a function of the instruction given after a short known delay and may be transmitted from the location of the experimentation platform or retrieved and played directly from the remote device.

### Automated Experiments

According to similar embodiments, the experimentation protocol may be broken down into a series of “subroutines.” For example, one subroutine could have an acid solution and a pH indicator being added to the DMF device in a single video clip, without allowing the user to choose which order to add them or whether to omit one ingredient or the other. A separate subroutine would be to array N droplets of this acid/pH indicator solution in a line on a DMF device to run side by side repeat experiments; a third subroutine would be to dispense an opposing droplet array (N droplet across and M droplets deep) of buffer solutions to titrate each acid/indicator droplet. Allowing experimentation protocols to be conducted via subroutines will enable the compilation of online subroutine libraries or databases where users can preview and then assemble select subroutines to achieve a unique process, thus saving time and effort and avoiding unnecessary errors in duplicating or constructing fundamental or repetitive actions.

The processes described above can be stored in a memory of a computer system as a set of instructions to be executed. In addition, the instructions to perform the processes described above could alternatively be stored on other forms of machine-readable media, including magnetic and optical disks. For example the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.).

Also disclosed herein are methods for reducing the costs associated with research, as well as for educational institutions allow students to experiment as a means of enriching the student's learning experience. Today, experimentation apparatuses are expensive. The present methods are designed to further centralize cost intensive research tools and allowing for remote access and control of those tools to entities that cannot afford them.

According to embodiments, users may conduct experiments without sending either samples to the centralized research facilities or making personal visits. Indeed, according to embodiments, an experiment may be conducted remotely from a remote computer, wherein the user has control of local apparatuses using remote devices, as described above.

Similarly, many educational institutions, particularly for students in elementary, middle, or high school cannot afford to provide students with research tools because they are cost prohibitive. Thus, students are limited to reading about the experiments and don't have the opportunity to actually try the experiments for themselves and observe results. The inventors have discovered methods that allow students to remotely experiment via a computer and observe prerecorded results. According to embodiments, prerecorded clips are obtained at each step, such that all or a useful number of combinations of experimentation protocol sequences are available to the student, who will observe the prerecorded results as they make choices in performing and viewing these experiments. Educational institutions that would otherwise be unable to provide access to cutting edge research tools due to the cost of purchase and maintenance of the tools may now offer them to students more cost effectively.

While the devices and methods have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A system comprising:
an experimentation platform controlled by a first device;
a second device in communication with the first device and located at a remote location;
wherein an experiment using the experimentation platform may be conducted by inputting at least one instruction on the second device; and
wherein the second device relays the at least one instruction to the first device for controlling the experimentation platform.

2. The system of claim 1, wherein the experiment is conducted in real-time.

3. The system of claim 1, wherein the experimentation platform comprises a plurality of recordings of at least one experiment.

4. The system of claim 3, wherein each experiment comprises a sequence of steps input by a user of the second device, wherein each step causes the system to display the recording associated with the step based on a sequence of preceding steps.

5. The system of claim 1, wherein the experimentation platform is a lab-on-a-chip apparatus.

6. The system of claim 5, wherein the lab-on-a-chip apparatus is a digital microfluidic device platform.

7. The system of claim 1, wherein at least one of the first device and second device is a computer.

8. The system of claim 1, wherein the second device is a cellular phone.

9. The system of claim 1, further comprising a database for storing video clips of experiments performed in real-time.

10. A method comprising:
providing an experimentation platform controlled by a first device; and
providing an interface to allow a second device to issue remote commands to the first device to control the experimentation platform remotely.

11. The method of claim 10, wherein the experimentation platform is controlled in real-time by a remote user.

12. The method of claims 10, wherein the experimentation platform comprises a lab-on-a-chip.

13. The method of claim 15, wherein the experiment was performed on a lab-on-a-chip apparatus.

14. The method of claim 12, wherein the lab-on-a-chip apparatus is a digital microfluidic device platform.

15. The method of claim 10, wherein the experimentation platform comprises a plurality of recordings of at least one experiment.

16. The method of claim 10, wherein at least one of the first device and second device is a computer.

17. A method comprising:
centralizing a plurality of experimentation sites into at least one subset of experimentation sites;
connection of at least one experimentation platform to a first set of devices; and
providing an interface to control the at least one experimentation platform apparatuses from remote location using a second device.

18. The method of claim 17, wherein the lab-on-a-chip comprises a digital microfluidic platform.

19. The method of claim 17, wherein a second device located at a remote location interfaces with the first device for controlling the at least one experimentation platform.

20. A machine-readable medium having program instructions stored thereon executable by a processing unit for performing the steps comprising:
providing for communication between a first device and a second device;
providing an interface for controlling an experimentation platform via the first device from the second device, wherein the experimentation platform and first device are located remotely.
